(19) United States
(12) Patent Application Publication
(10) Pub. No.: US 2018/0090741 A1
(43) Pub. Date: Mar. 29, 2018

(54) LITHIUM ION BATTERY

(71) Applicants: Jiangsu Huadong Institute of Li-Ion Battery Co., Ltd., Suzhou (CN); Tsinghua University, Beijing (CN)

(72) Inventors: Xiang-Ming He, Beijing (CN); Yong Yang, Suzhou (CN); Jian-Jun Li, Beijing (CN); Li Wang, Beijing (CN); Hong-Sheng Zhang, Suzhou (CN); Yu-Ming Shang, Beijing (CN); Guo-Hua Li, Suzhou (CN)

(73) Assignees: Jiangsu Huadong Institute of Li-Ion Battery Co., Ltd., Suzhou (CN); Tsinghua University, Beijing (CN)

(21) Appl. No.: 15/818,753

(22) Filed: Nov. 21, 2017

Related U.S. Application Data
(63) Continuation of application No. PCT/CN2016/078890, filed on Apr. 8, 2016.

(30) Foreign Application Priority Data
May 25, 2015 (CN) 201510269595.5

(51) Int. Cl. H01M 2/34; H01M 10/0525; H01M 10/0587; H01M 2/12

(52) U.S. Cl. CPC H01M 2/345; H01M 10/0525; H01M 2200/20; H01M 2/12; H01M 10/0587

(57) ABSTRACT

The present disclosure provides a lithium ion battery comprising a base, a winding column, a shell, a cover cap, and a cell. The winding column is disposed on the base. The cell is winded onto an outer surface of the winding column. The shell is sleeved outside an outer surface of the cell, and two ends of the shell are respectively connected to the base and the cover cap to seal the cell. The lithium ion battery further comprises a secure structure body disposed between the winding column and the cell. The secure structure body comprises an elastic layer and a plurality of acicular members disposed in the elastic layer. The plurality of acicular members has a plurality of pointed ends, and the plurality of pointed ends points to the cell.

### CROSS-REFERENCE TO RELATED APPLICATIONS

This application claims all benefits accruing under 35 U.S.C. § 119 from China Patent Application No. 201510269595.5, filed on May 25, 2015 in the State Intellectual Property Office of China, the content of which is hereby incorporated by reference. This application is a continuation under 35 U.S.C. § 120 of international patent application PCT/CN2016/078890 filed on Apr. 8, 2016, the content of which is also hereby incorporated by reference.

### FIELD

The present disclosure relates to a lithium ion battery.

### BACKGROUND

In recent years, due to advantages such as high voltage, large cycling number, and long storage time, a lithium ion battery has been widely applied not only in portable electronic devices, but in large and medium-sized electric devices such as electric cars, electric bicycles, and electric tools.

In charging and discharging the lithium ion battery, a space between a cathode and an anode of the lithium ion battery will change due to expansion of electrode plates and decomposition and gasification of electrolyte liquids, thereby changing an internal resistance of the lithium ion battery. An internal pressure of the battery increases with gas accumulation inside the battery.

### SUMMARY

A lithium ion battery comprises a base, a winding column, a shell, a cover cap, and a cell. The winding column is disposed on the base. The cell is winded onto an outer surface of the winding column. The shell is sleeved outside an outer surface of the cell, and two ends of the shell are respectively connected to the base and the cover cap to seal the cell. The lithium ion battery further comprises a secure structure body disposed between the winding column and the cell. The secure structure body comprises an elastic layer and a plurality of acicular members disposed in the elastic layer. The plurality of acicular members has a plurality of pointed ends. The plurality of pointed ends points to the cell.

In the present disclosure, the secure structure body is disposed between the winding column and the cell. The secure structure body comprises the elastic layer and the plurality of acicular members disposed in the elastic layer. The plurality of acicular members has the plurality of pointed ends. The plurality of pointed ends points to the cell. When an internal expansion of the lithium ion battery reaches a certain expansion, the secure structure body will be pressed by an expansion force, the elastic layer will have contracted, and the plurality of acicular members will be exposed from the elastic layer to contact the cell and puncture into the cell, which causes a contact of the anode and the cathode of the lithium ion battery and a short circuit inside the lithium ion battery leading to a short-circuit discharge. In addition, when the lithium ion battery is hit and pressed drastically by an external force, the plurality of acicular members will also contact the cell and puncture into the cell, which causes a contact of the anode and the cathode of the lithium ion battery leading to a discharge of the lithium ion battery at a low current rate to disable the battery.

### BRIEF DESCRIPTION OF THE DRAWINGS

FIG. 1 is a schematic perspective view of one embodiment of a lithium ion battery.

FIG. 2 is an exploded view of one embodiment of the lithium ion battery.

FIG. 3 is a cross-sectional view along line of FIG. 1.

FIG. 4 is a schematic perspective view of one embodiment of a winding column and a base of the lithium ion battery.

FIGS. 5A and 5B are cross-sectional views of embodiments of a plurality of acicular members disposed in an elastic layer.

FIG. 6 is a schematic view of one embodiment of the lithium ion battery having the elastic layer before and after being pressed.

FIG. 7 is a schematic perspective view of one embodiment of a cell of the lithium ion battery.

FIG. 8 is a cross-sectional view of one embodiment of a cover cap along VII-VII line of FIG. 2.

### DETAILED DESCRIPTION

A detailed description with the above drawings is made to further illustrate the present disclosure.

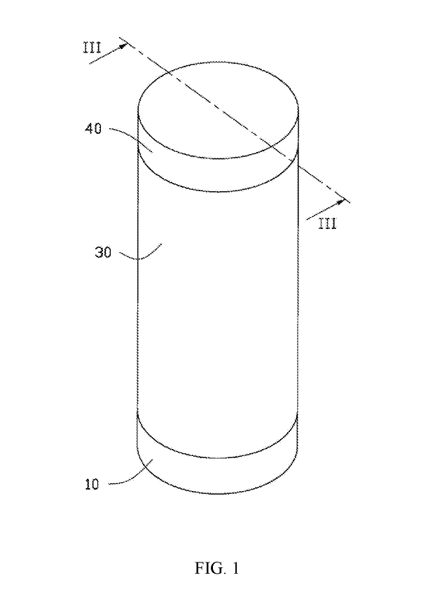

Referring to FIGS. 1-3, one embodiment of a lithium ion battery 100 comprises a base 10, a winding column 20, a shell 30, a cover cap 40, and a cell 60. The winding column 20 can be disposed on the base 10. The cell 60 can be winded onto an outer surface of the winding column 20. The shell 30 can be sleeved outside an outer surface of the cell 60. Two ends of the shell 30 can be respectively connected to the base 10 and the cover cap 40 to seal the cell 60. The lithium ion battery 100 can further comprise a secure structure body 50. The secure structure body 50 can be disposed between the winding column 20 and the cell 60. The secure structure body 50 can comprise an elastic layer 51 and a plurality of acicular members 52. The plurality of acicular members 52 can be disposed in the elastic layer 51 and has a plurality of pointed ends. The plurality of pointed ends of the plurality of acicular members 52 can point to the cell 60.

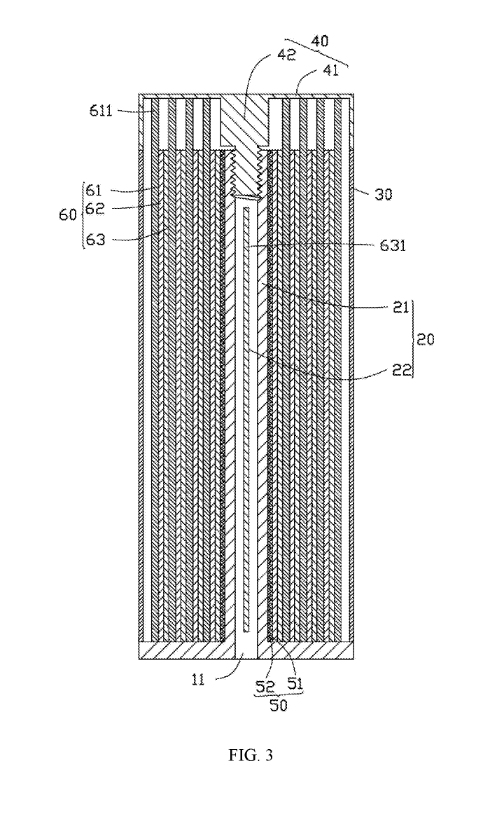

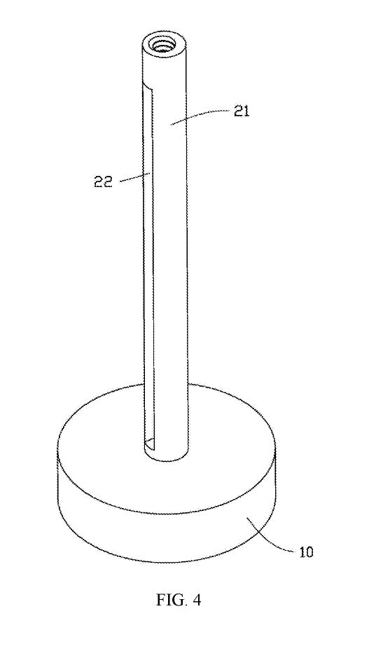

Referring to FIG. 3 and FIG. 4, the base 10 is configured to support the winding column 20. A pumping hole 11 can be defined on the base 10. A gas generated inside the lithium ion battery 100 in use can be pumped out through the pumping hole 11 to form a negative pressure inside the lithium ion battery 100. In one embodiment, the pumping hole 11 can be defined at the center of the base 10 corresponding to the winding column 20. A screw thread (not shown) can be defined on an outer edge of the base 10 to join the base 10 with the shell 30. A material of the base 10 can be a conductive material. In one embodiment, the material of the base 10 is a hard and light aluminum material.

The winding column 20 can be located on the base 10. The winding column 20 can be a hollow structure and can comprise a cylinder wall 21. An opening 22 can be defined on the cylinder wall 21 to fix one end of the cell 60. A length of the opening 22 can be set according to a width of the cell 60. In one embodiment, the winding column 20 can be a hollow structure having two open ends. One of the two open ends of the winding column 20 can be connected to the base 10 corresponding to the pumping hole 11, and communicate with the pumping hole 11. The base 10 and the winding column 20 can be two elements or can form as a one-piece unitary structure. In one embodiment, the opening 22 is defined on the cylinder wall 21 of the winding column 22, and the base 10 and the winding column 20 forms the one-piece structure. A material of the winding column 20 can be a conductive material. The base 10 and the winding column 20 can be used as an anode lug of the lithium ion battery 100. The material of the winding column 20 can be different from or the same as the material of the base 10. In one embodiment, the materials of the winding column 20 and the base 10 are both the hard and light aluminum material.

The secure structure body 50 can be disposed on at least a part of the outer surface of the winding column 20. When the opening 22 is defined on the cylinder wall 21 of the winding column 20, the secure structure body 50 can be disposed on at least a part of the outer surface of the winding column 20, and the opening 22 can be exposed and not covered by the secure structure body 50 to fix the cell 60.

The lithium ion battery 100 can comprise one secure structure body 50 or a plurality of secure structure bodies 50. When the lithium ion battery 100 comprises one secure structure body 50, the one secure structure body 50 can be winded onto the whole outer surface of the winding column 20, or winded onto a part of the outer surface of the winding column 20. When the lithium ion battery 100 comprises the plurality of secure structure bodies 50, the plurality of secure structure bodies 50 can be spaced from each other, or disposed side by side and contact each other on at least a part of the outer surface of the winding column 20. The plurality of secure structure bodies 50 can be arranged along an axial direction of the winding column 20, or arranged around the winding column 20.

At least a part of the elastic layer 51 can be disposed between the plurality of acicular members 52 and the cell 60. The elastic layer 51 can have elasticity and contractility. After the lithium ion battery 100 has been charged and discharged in a predetermined cycle number of cycles or when the lithium ion battery 100 is pressed by an external force, the plurality of pointed ends can be exposed from the elastic layer 51 to contact and puncture into the cell 60 to short-circuit the cell 60. A hardness of the elastic layer 51 can ensure that in the winding process of the cell 60, the plurality of pointed ends is not exposed from the elastic layer 51 and do not contact the cell 60.

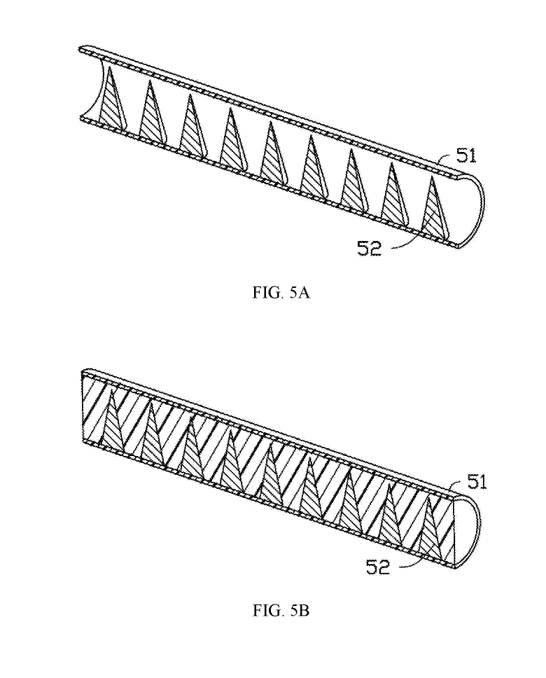

The manner to dispose the plurality of acicular members 52 in the elastic layer 51 is not limited as long as the plurality of pointed ends of the plurality of acicular members 52 point to the cell 60 and do not contact the cell 60. In one embodiment, an accommodation space can be defined in the elastic layer 51, and the plurality of acicular members 52 can be disposed in the accommodation space defined in the elastic layer 51. In one embodiment, the plurality of acicular members 52 can be embedded in the elastic layer 51. A shape of the elastic layer 51 is not limited and can be varied according to needs. The elastic layer 51 can be a layer structure, a columnar structure, or a tubular structure. In one embodiment, referring to FIG. 5A, the elastic layer 51 is a tubular structure. An accommodation space is defined in the elastic layer 51, and the plurality of acicular members 52 are disposed in the accommodation space defined in the elastic layer 51. In another embodiment, referring to FIG. 5B, the elastic layer 51 is a columnar structure, and the plurality of acicular members 52 are embedded in the elastic layer 51. A fixation manner of the plurality of acicular members 52 is not limited as long as the plurality of pointed ends of the plurality of acicular members 52 can point to the cell 60. The plurality of acicular members 52 can be fixed on the outer surface of the winding column 20, or fixed by the elastic layer 51 by being embedded in the elastic layer 51. A material of the elastic layer 51 can be a corrosion resistant non-conductive material. A material of the plurality of acicular members 52 can be a conductive metal. In one embodiment, the elastic layer 51 is a layer structure, the plurality of acicular members 52 are embedded in the elastic layer 51 and fixed by the elastic layer 51, and the material of the plurality of acicular members 52 is gold.

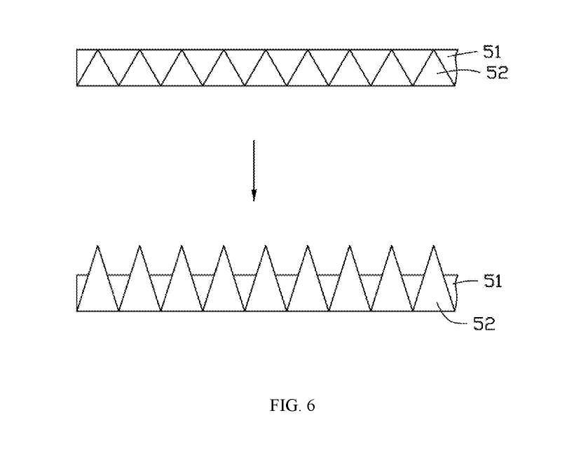

In the charging and discharging process of the lithium ion battery 100, the electrode plates of the lithium ion battery 100 can be thickened and a side reaction can occur due to the irreversible capacities of the electrode plates, which causes an internal expansion of the lithium ion battery 100 and a mutual press between the electrode plates. Referring to FIG. 6, when the internal expansion of the lithium ion battery 100 reaches a certain expansion, the secure structure body 50 will be pressed by the expansion force, the elastic layer 51 will be contracted, and the plurality of acicular members 52 will be exposed from the elastic layer 51 to contact the cell 60 and puncture through a separator of the cell 60, which causes a contact of an anode and a cathode of the lithium ion battery 100 and causes a short circuiting of the lithium ion battery 100, so that the lithium ion battery 100 can be disabled due to a short-circuit discharge. In addition, when the lithium ion battery 100 is hit and pressed drastically from an external force, the plurality of acicular members 52 will also contact the cell 60 and puncture through the separator of the cell 60, thereby causing a contact of the anode and the cathode of the lithium ion battery 100 and discharging the lithium ion battery 100 at a low current rate, after which the lithium ion battery 100 is disabled.

One end of the cell 60 can be fixed through the opening 22 defined on the winding column 20. The cell 60 can be wholly winded onto the outer surface of the secure structure body 50. In making process of the lithium ion battery 100, in order to prevent the plurality of pointed ends of the plurality of acicular members 52 from being exposed from the elastic layer 51 and contacting the cell 60, when winding the cell 60 onto the outer surface of the secure structure body 50, a strength for winding the cell 60 can be controlled to ensure that the elastic layer 51 is not pressed by the cell 60 too far. In one embodiment, a tightness of winding of the cell 60 can be adjusted by a winding device of the lithium ion battery 100. When winding the first cycle of the cell 60 closing to the secure structure body 50, the strength for winding the cell 60 can be controlled to ensure that the secure structure body 50 is not pressed by the cell 60 too far thereby preventing the plurality of pointed ends of the plurality of acicular members 52 from being exposed and contacting the cell 60.

The cell 60 can comprise a cathode plate 61, a separator 62, and an anode plate 63 stacked with each other. The cathode plate 61, the separator 62, and the anode plate 63 stacked with each other can be winded onto the winding column 20 by conventional battery winding methods to form a winding body. The cathode plate 61 and the anode plate 63 are spaced by the separator 62 in the winding body.

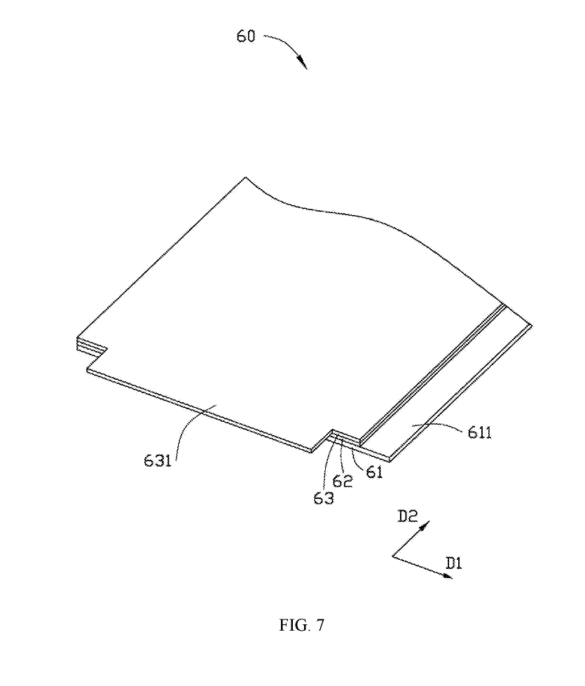

Referring to FIG. 7, the cathode plate 61, the separator 62, and the anode plate 63 can be stacked together. A first end of the cathode plate 61 can have a cathode blank foil 611. A second end of the anode plate 63 can have an anode blank foil 613. The cathode blank foil 611 is a foil with no cathode active material coating. The anode blank foil 613 is a foil with no anode active material coating. The cathode plate 61, the separator 62, and the anode plate 63 stacked with each other can have a width direction D1 and a length direction D2. When winding the cell 60 onto the winding column 20, the width direction D1 can be perpendicular to the base 10. The length direction D2 can be perpendicular to the width direction D1. The anode blank foil 631 can be disposed on the second end of the anode plate 63 extending along the length direction D2, and not overlapped with the cathode plate 61 and the separator 62 in the length direction D2. The cathode blank foil 611 can be disposed on the first end of the cathode plate 61 extending along the width direction D1, and not overlapped with the cathode plate 61 and the separator 62 in the width direction D1.

The anode blank foil 631 of the anode plate 63 can be fixed on the winding column 20 through the opening 22 defined on the cylinder wall 21. The manner to fix the anode blank foil 631 of the anode plate 63 on the winding column 20 through the opening 22 is not limited, as long as the anode blank foil 631 of the anode plate 63 is fixed on the winding column 20. In one embodiment, the anode blank foil 631 of the anode plate 63 is put into the winding column 20 through the opening 22, and a snap-fit device is disposed at the opening 22 to fasten the anode blank foil 631 in the winding column 20, thereby fixing the anode plate 63 on the winding column 20, which does not use any welding device and decreases energy consumption in production compared with conventional welding methods to fix the anode plate 63 on the winding column 20.

In the width direction D1, a length of the cathode plate 61 is larger than a length of the separator 62 and a length of the anode 63. The part of the cathode plate 61 extending beyond the separator 62 and the anode plate 63 in the width direction D1 is the cathode blank foil 611. After the cell 60 winding onto the winding column 60, the cathode plate 61 will not be aligned with the separator 62 and the anode plate 63, and will extend out relative to the separator 62 and the anode plate 63. The cathode blank foil 611 can be used as a cathode lug of the lithium ion battery 100.

A shape of the shell 30 is not limited and can be varied according to needs. A material of the shell 30 can be an insulating material. In one embodiment, the shape of the shell 30 is cylindrical, and the material of the shell 30 is a ceramic material.

Referring to FIG. 3, the shell 30 is sleeved outside the outer surface of the cell 60. The shell 30 can comprise a first end and a second end opposite to each other. The first end of the shell 30 can be connected to the base 10, and the second end of the shell 30 can be connected to the cover cap 40. The first end and the second end of the shell 30 can respectively have a screw thread (not shown) to connect the base 10 and the cover cap 40. An electrolyte liquid corrosion resistant material can be coated on the screw thread of the first end of the shell 30 and the screw thread of the base 10 before connecting the first end of the shell 30 to the base 10. In one embodiment, an internal thread is defined on the first end of the shell 30 to cooperate with an external thread defined on the base 10 to fix the shell 30 with the base 10.

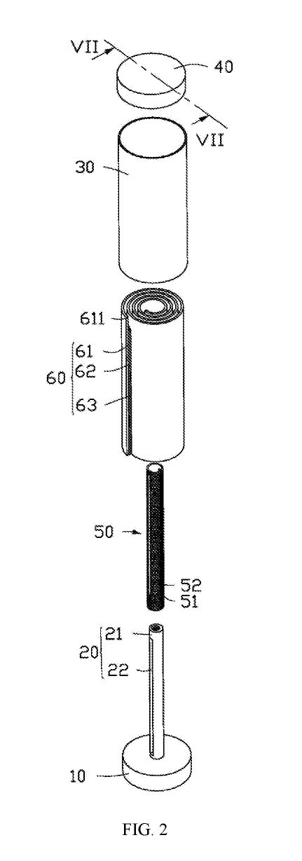

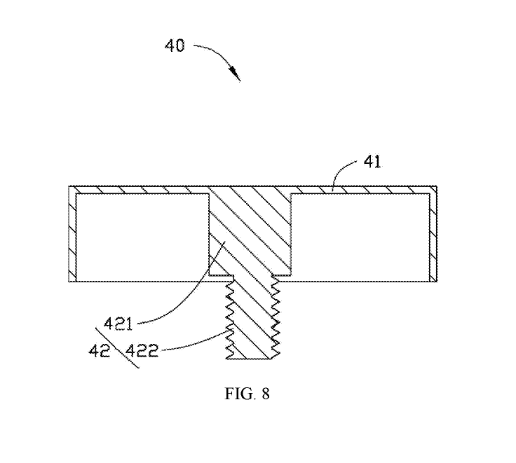

Referring to FIG. 1, FIG. 2, and FIG. 3, the cover cap 40 can be connected with the shell 30, and seal the cell 60 together with the base 10. Referring to FIG. 2 and FIG. 8, the cover cap 40 can comprise a head cover 41 and a core column 42 connected with the head cover 41. The head cover 41 can be connected to the shell 30, and one end of the core column 42 can be connected to the winding column 20, so that the cover cap 40 is connected to the shell 30.

A shape of the head cover 41 is not limited as long as the head cover 41 can be connected to the shell 30. The head cover 41 can be a structure defining a groove or a planar structure. The head cover 41 can be a conductive structure and be electrically contacted to the cathode blank foil 611 of the cathode plate 61 used as the cathode lug, thereby exposing the cathode lug of the lithium ion battery 100 and decreasing polarization of the lithium ion battery 100. A material of the head cover 41 can be a conductive material. A shape of the head cover 41 is not limited as long as the head cover 41 can be connected to the shell 30. In one embodiment, the shape of the head cover 41 is U-shaped with a groove.

The core column 42 can be a solid cylindrical structure formed by a first part 421 and a second part 422. A diameter of the first part 421 can be different from a diameter of the second part 422. The diameter of the first part 421 can be larger than the diameter of the second part 422. A material of the core column 42 can be an electrolyte liquid corrosion resistant and non-conductive material. In one embodiment, the material of the core column 42 is polytetrafluoroethylene.

The head cover 41 can be connected to the shell 30. The first part 421 can be connected to the head cover 41. The second part 422 can be connected to the winding column 20. The connecting manners between the head cover 41 and the shell 30, between the first part 421 and the head cover 41, and between the second part 422 and the winding column 20 are not limited as long as the above connections are realized. The head cover 41 and the shell 30, the first part 421 and the head cover 41, and the second part 422 and the winding column 20, can be respectively connected by a bonding manner or snap-fit manner. In one embodiment, screw threads can be defined on connection joints of the head cover 41 and the shell 30, the first part 421 and the head cover 41, and the second part 422 and the winding column 20 to realize the above connections.

The diameter of the second part 422 of the core column 42 can be substantially equal to an inner diameter of the winding column 20. A difference between the diameter of the first part 421 and the diameter of the second part 422 can be substantially equal to a thickness of the cylinder wall 21 of the winding column 20.

In the present disclosure, the secure structure body is disposed between the winding column and the cell. The secure structure body comprises the elastic layer and the plurality of acicular members is disposed in the elastic layer. The plurality of acicular members has the plurality of pointed ends. The plurality of pointed ends points to the cell. When the internal expansion of the lithium ion battery reaches a certain extent, the secure structure body will be pressed by the expansion force, the elastic layer will be contracted, and the plurality of acicular members will be exposed from the elastic layer to contact the cell and puncture into the cell, which causes a contact of the anode and the cathode of the lithium ion battery and a short circuit of the lithium ion battery, so that the lithium ion battery can be disabled due to the short-circuit discharge. In addition, when the lithium ion battery is hit and pressed drastically by an external force, the plurality of acicular members will also contact the cell and puncture into the cell, thereby causing contact of the anode and the cathode of the lithium ion battery and discharge of the lithium ion battery at a low current rate, after which the lithium ion battery is disabled.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A lithium ion battery, comprising:
a base;
a winding column disposed on the base;
a cover cap;
a cell winded onto an outer surface of the winding column;
a secure structure body disposed between the winding column and the cell; and
a shell sleeved outside an outer surface of the cell, wherein two ends of the shell are respectively connected to the base and the cover cap to seal the cell, the secure structure body comprises an elastic layer and a plurality of acicular members disposed in the elastic layer, the plurality of acicular members has a plurality of pointed ends, and the plurality of pointed ends points to the cell.

2. The lithium ion battery of claim 1, wherein when an internal expansion of the lithium ion battery reaches a predetermined expansion, or the lithium ion battery is pressed by an external force, the plurality of acicular members is exposed from the elastic layer to puncture the cell and cause a short circuit of the lithium ion battery.

3. The lithium ion battery of claim 1, wherein the secure structure body is disposed on at least a part of the outer surface of the winding column.

4. The lithium ion battery of claim 1, wherein a number of the secure structure body is one, and the secure structure body is winded onto the whole outer surface of the winding column.

5. The lithium ion battery of claim 1, wherein the secure structure body comprises a plurality of secure structure bodies spaced from each other on at least a part of the outer surface of the winding column.

6. The lithium ion battery of claim 1, wherein the secure structure body comprises a plurality of secure structure bodies disposed side by side and contacting each other on at least a part of the outer surface of the winding column.

7. The lithium ion battery of claim 1, wherein at least a part of the elastic layer is disposed between the plurality of acicular members and the cell.

8. The lithium ion battery of claim 1, wherein an accommodation space is defined in the elastic layer, and the plurality of acicular members are disposed in the accommodation space.

9. The lithium ion battery of claim 8, wherein the plurality of acicular members is fixed on the outer surface of the winding column.

10. The lithium ion battery of claim 1, wherein the plurality of acicular members is embedded in the elastic layer.

11. The lithium ion battery of claim 1, wherein the cell comprises a cathode plate, a separator, and an anode plate stacked with each other, the cathode plate comprises a cathode blank foil, the cathode blank foil electrically contacts the cover cap, and the cover cap is used as a cathode lug.

12. The lithium ion battery of claim 11, wherein the cathode blank foil extends out from one side of the cell along an axial direction of the winding column and contact the cover cap, and the cover cap is made of a conductive material.

13. The lithium ion battery of claim 11, wherein the cover cap comprises a head cover and a core column connected with the head cover, the head cover is connected to the shell and electrically contacts the cathode blank foil, and one end of the core column is connected to the winding column.

14. The lithium ion battery of claim 1, wherein the winding column is a hollow structure and comprises a cylinder wall, and an opening is defined on the cylinder wall to fix the cell.

15. The lithium ion battery of claim 14, wherein the cell comprises a cathode plate, a separator, and an anode plate stacked with each other, the anode plate comprises an anode blank foil, the anode blank foil extends out of one side of the cell along a radial direction of the winding column, and the anode blank foil is fixed on the winding column through the opening.

16. The lithium ion battery of claim 15, wherein the anode blank foil is put inside the winding column through the opening, and a snap-fit device is disposed at the opening to fasten the anode blank foil in the winding column.

17. The lithium ion battery of claim 1, wherein a pumping hole is defined at the center of the base, the winding column is a hollow structure having two open ends, and one of the two open ends of the winding column is connected to the base corresponding to the pumping hole and communicating with the pumping hole.

18. The lithium ion battery of claim 1, wherein the base and the winding column are made of a conductive material and are used as an anode lug.
